(19) United States
(12) Patent Application Publication
(10) Pub. No.: US 2007/0052127 A1
(43) Pub. Date: Mar. 8, 2007

(54) Method of making silicon rubber product

(75) Inventors: Chin-Lun Chu, Taichung City (TW); Wen-Fu Yang, Changhua County (TW)

Correspondence Address: BIRCH STEWART KOLASCH & BIRCH, PO BOX 747, FALLS CHURCH, VA, 22040-0747, US

(73) Assignee: LEE BOU LABEL ENTERPRISE CO., LTD.

(21) Appl. No.: 11/513,138

(22) Filed: Aug. 31, 2006

(30) Foreign Application Priority Data
Sep. 2, 2005 (TW) 94130217

(51) Int. Cl. B32B 25/20

(52) U.S. Cl. 264/135

(57) ABSTRACT

A method of making a silicon rubber product on a back thereof includes the steps of: providing RTV silicon rubber in a cavity of a mold, and then heating the RTV silicon rubber for vulcanization. The vulcanized is coated with primer to help it coupled with another silicon rubber. After that, HTV silicon rubber is put in the mold, and then hot molding process is applied on the mold to integrate the silicon rubbers as a single unit. The silicon rubber product made by the method of the present invention has no problem of “bleeding”. Furthermore, the silicon rubber product may be fabricated with fine pattern and multi-stage pattern.

### BACKGROUND OF THE INVENTION

1. Field of the Invention

The present invention relates generally to a silicon rubber product, and more particular to a method of making a silicon product with a fine pattern.

2. Description of the Related Art

JP Patent Publication no. 2000-317966 disclosed a conventional method of making a silicon rubber product, which includes the steps of dosing molten room temperature vulcanization (RTV) silicon rubber in a bottom layer of a cavity of a mold, and then providing a silicon rubber sheet in a top layer of the cavity of the mold. The mold is treated by hot molding for vulcanization of the silicon rubbers.

When the mold is treated by hot molding, the RTV silicon rubber is still in molten condition, such that it usually occurs bleeding on the molten RTV silicon rubber that mix up the pattern of the silicon rubber product, especially for the silicon rubber product with a fine pattern. Even for the silicon rubber product with bigger pattern, the products made by the conventional method still have a greater defective ratio.

### SUMMARY OF THE INVENTION

The primary objective of the present invention is to provide a method of making a silicon rubber product, which has no problem of bleeding.

The secondary objective of the present invention is to provide a method of making a silicon rubber product, which may fabricate the silicon rubber product with a multi-stage pattern.

According to the objectives of the present invention, a method of making a silicon rubber product includes the steps of:

a) Preparing a mold having a multilayer cavity, wherein the cavity includes a pattern layer and a base layer above the pattern layer.

b) Providing room temperature vulcanization (RTV) silicon rubber in the pattern layer of the cavity of the mold.

c) Heating the RTV silicon rubber for vulcanization.

d) Coating primer on the vulcanized RTV silicon rubber.

e) Providing high temperature vulcanization (HTV) in the base layer of the cavity of the mold.

f) Performing a hot molding process on the mold; and

g) Opening the mold to get a silicon rubber product.

The silicon rubber product made by the present invention has a base, which is formed from the HTV silicon rubber, and a pattern, which is formed from the RTV silicon rubber, on the base.

### BRIEF DESCRIPTION OF THE DRAWINGS

FIG. 1 is a sectional view of the bottom member of the mold of a preferred embodiment of the present invention;

FIG. 2 is a sketch diagram of the first preferred embodiment of the present invention, showing providing RTV rubber in the first pattern layer of the bottom member of the mold;

FIG. 3 is a sketch diagram of the first preferred embodiment of the present invention, showing coating primer on the RTV rubber;

FIG. 4 is a sketch diagram of the first preferred embodiment of the present invention, showing providing the RTV silicon rubber in the second pattern layer of the bottom member of the mold, and coating primer on the RTV rubber;

FIG. 5 is a sketch diagram of the first preferred embodiment of the present invention, showing providing HTV rubber in the base layer of the bottom member of the mold;

FIG. 6 is a sketch diagram of the first preferred embodiment of the present invention, showing the mold under hot molding molding;

FIG. 7 is a perspective view of the silicon rubber product made by the method of the present invention; and

FIG. 8 is a sectional view of the mold of a second preferred embodiment of the present invention for fabrication of the silicon rubber product with patterns on double sides.

### DETAILED DESCRIPTION OF THE INVENTION

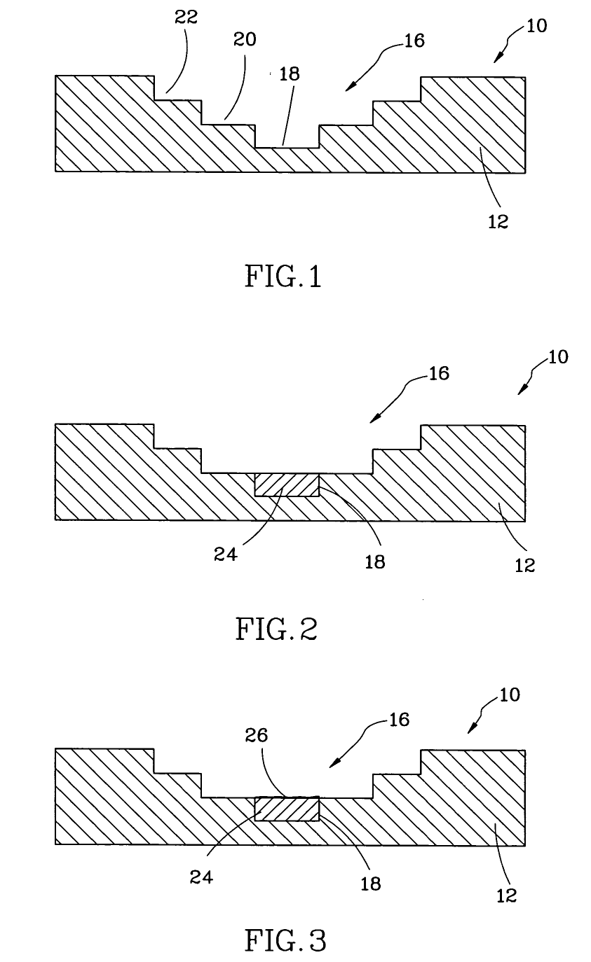

As shown in FIG. 1 to FIG. 6, a method of making a silicon rubber product includes the steps of:

a) Preparing a mold 10.

As shown in FIG. 1, the mold 10 has a bottom member 12 and an upper member 14. The bottom member 12 has a multilayer cavity 16, which consists of, from bottom to top, a first pattern layer 18, a seconds pattern layer 20 and a base layer 22.

b) Dosing molten room temperature vulcanization (RTV) silicon rubber 24 in the first pattern layer 18 of the cavity 16 of the bottom member 12 of the mold 10.

As shown in FIG. 2, microinjection and automatic control process is applied in this step to dose RTV silicon rubber 24 in the first pattern layer 18 of the bottom member 12. The RTV silicon rubber 24 may has various colors to be dosed in different portions of the first pattern layer 18 according to designation.

c) Heating the RTV silicon rubber 24 for vulcanization.

The bottom member 12 is sent to a stove (not shown) for heating under 120° C. to 180° C. for 15 seconds to 25 seconds. The RTV silicon rubber 24 will be vulcanized.

d) Cooling the RTV silicon rubber 24.

After heating, the bottom member 12 is sent to a cooling device (not shown) for cooling. The cooling device has liquid (usually is water) of 5° C. to 20° C. flowing to cool the RTV silicon rubber 24 to room temperature.

e) Clearing the RTV silicon rubber 24 out of the first pattern layer 18.

In the microinjection, there might be some RTV silicon rubber 24 left on the bottom member 12 rather in the first pattern layer 18. This RTV silicon rubber (not shown) must be removed by wiping or other clearing processes.

f) As shown in FIG. 3, coating primer 26 on the RTV silicon rubber 24.

The vulcanized RTV silicon rubber 24 has a very smooth surface that is hard to couple another silicon rubber. The primer 26 may activate the surface of vulcanized RTV silicon rubber 24 to help it coupled with another silicon rubber.

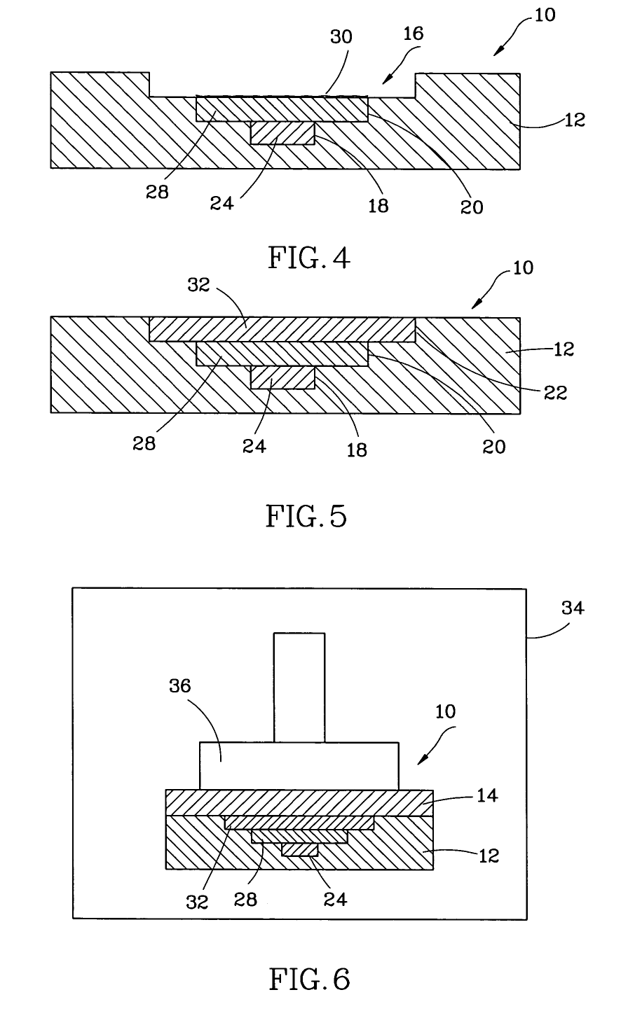

g) Dosing molten RTV silicon rubber 28 in the second pattern layer 20 of the bottom member 12 of the mold 10, and then performing the heating, cooling, clearing steps in sequence like above. After that, the RTV silicon rubber 28 is coated with primer 30 also, as shown in FIG. 4.

h) As shown in FIG. 5, putting a high temperature vulcanization (HTV) silicon rubber block 32 with a size and shape similar to the base layer 22 of the bottom member 12 of the mold 10 in the base layer 22.

i) As shown in FIG. 6, covering the upper member 14 onto the bottom member 12, and then sending the mold 10 to a chamber 34 for hot molding treatment.

To prevent air left in the cavity of the mold 10 or in the silicon rubbers, an air-extracting apparatus (not shown) is connected to the chamber 34 to remove the air. When the air-extracting apparatus is working, a pressing member 36 is pressing the mold 10 repeatedly. After that, filling air in the chamber 34 again, and heating up to 180° C. to 250° C. for 30 seconds to 450 seconds. Repeating aforesaid steps for 2 times to 8 times to make sure there is no air in the cavity 16 nor in silicon rubbers and the silicon rubbers will be integrated as a single unit.

j) At last, opening the mold 10 to get a silicon rubber product 38.

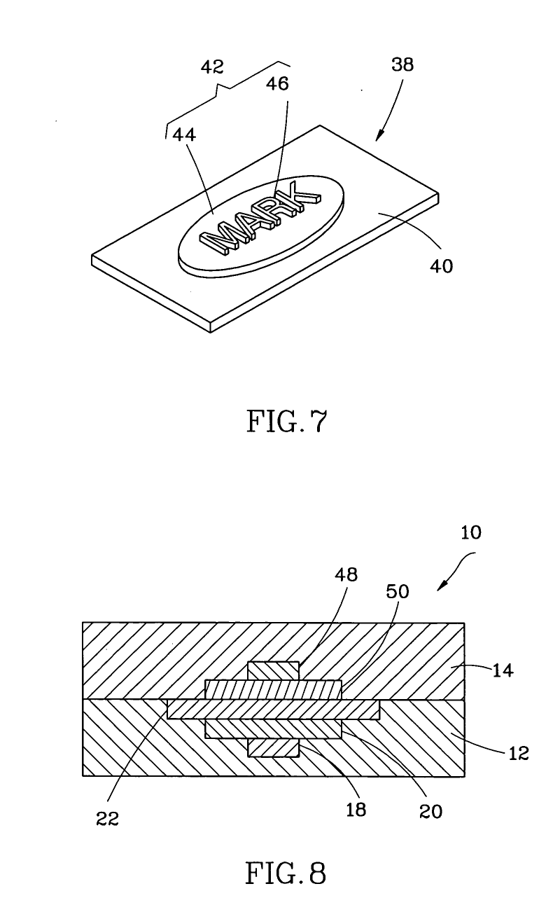

As shown in FIG. 7, the silicon rubber product 38 includes a base 40, which is formed from the HTV silicon rubber 32, and a two-stage pattern 42, which is formed from the RTV silicon rubbers 24, 28, on the base 40. The RTV silicon rubbers 24, 28 will not occur bleeding in the hot molding process (the step i) because that the RTV silicon rubbers 24, 28 have been solidified in the prior steps. In the practice, the method of the present invention may fabricate the fine pattern only having 0.2 mm in width. Furthermore, the method of the present invention provides a lower defective ratio in production of the silicon rubber products.

In addition, the conventional method mentioned in the background only can fabricate the silicon rubber products with single-stage pattern because that the molten RTV silicon rubber can not stack on the molten RTV silicon rubber. The method of the present invention can fabricate the silicon rubber products with multi-stage pattern. Such as the silicon rubber product 38 shown in FIG. 7, the pattern 42 includes a bottom pattern 44, which is formed from the RTV silicon rubber 24 in the first pattern layer 18, and an upper pattern 46, which is formed from the RTV silicon rubber 28 in the second pattern layer 20, stacked on the bottom pattern 44. According to the method of the present invention, it is easy to fabricate the rubber products with a pattern of three or more stages, which only have to design the mold with three or more pattern layers.

FIG. 8 shows a mold 10 of the second preferred embodiment of the present invention, which may fabricate silicon rubber products with multi-stage patterns on double sides. The mold 10 has a bottom member 12 and an upper member 14 also. The bottom member 12 includes a plurality of pattern layers 18, 20 and a base layer 22, and the upper member 14 includes a plurality of pattern layers 48, 50. It is easy to perform the same steps of dosing RTV silicon rubbers in the pattern layers 18, 20, 48, and 50, and the heating, cooling, and coating primer steps respectively to fabricate the silicon rubber product with multi-stage patterns on opposite sides of the base.

In some conditions, the silicon rubber products need thicker base or the base with a pattern on a back thereof. It may provide the upper member having a base layer only or having both of the base layer and the pattern layer(s). Performing the aforesaid steps may get the silicon rubber products as desire.

What is claimed is:

1. A method of making a silicon rubber product, comprising the steps of:
a) preparing a mold having a multilayer cavity, wherein the cavity includes a pattern layer and a base layer above the pattern layer;
b) providing room temperature vulcanization (RTV) silicon rubber in the pattern layer of the cavity of the mold;
c) heating the RTV silicon rubber for vulcanization;
d) coating primer on the vulcanized RTV silicon rubber;
e) providing high temperature vulcanization (HTV) in the base layer of the cavity of the mold;
f) performing a hot molding process on the mold; and
g) opening the mold to get a silicon rubber product with a base, which is formed from the HTV silicon rubber, and a pattern, which is formed from the RTV silicon rubber, on the base.

2. The method as defined in claim 1, wherein the RTV silicon rubber is heated up to 120° C. to 180° C. for 15 seconds to 25 seconds in the step c.

3. The method as defined in claim 1, further comprising the steps of cooling the RTV silicon rubber to room after the step c.

4. The method as defined in claim 3, wherein the cooling step includes the step of sending the mold to a cooling device with liquid of 5° C. to 20° C. for circulation.

5. The method as defined in claim 1, further comprising the step of removing the RTV silicon rubber left out of the pattern layer after the step c.

6. The method as defined in claim 1, wherein the step f comprising the sub-steps of:
1) sending the mold into a chamber;
2) extracting gas from the chamber and pressing the mold repeatedly;
3) filling the chamber with gas again; and
4) heating the mold.

7. The method as defined in claim 6, further comprising the sub-step of repeating the sub-step 2 and the sub-step 3 for several time prior to the sub-step 4.

8. The method as defined in claim 6, wherein the mold is heated up to 120° C. to 180° C. for 30 seconds to 450 seconds in the sub-step 4.

9. A method of making a silicon rubber product, comprising the steps of:
a) preparing a mold having a multilayer cavity, wherein the cavity includes a plurality of pattern layers and a base layer above the pattern layers;
b) providing room temperature vulcanization (RTV) silicon rubber in the pattern layer of the cavity of the mold;
c) heating the RTV silicon rubber for vulcanization;
d) coating primer on the vulcanized RTV silicon rubber;
e) repeating the step b to step d until all of the pattern layers had been filled with the RTV silicon rubber;
e) providing high temperature vulcanization (HTV) silicon rubber in the base layer of the cavity of the mold;
f) performing a hot molding process on mold; and
g) opening the mold to get a silicon rubber product with a base, which is formed from the HTV silicon rubber, and a multi-stage pattern, which is formed from the RTV silicon rubbers, on the base.

10. The method as defined in claim 9, wherein the mold includes a bottom member and an upper member, which the bottom has the multilayer cavity and the upper member has a cavity with at least a pattern layer, and the method further includes the steps of performing the step b to the step e in the pattern layer of the pattern layer of the upper member.
